(19) United States
(12) Patent Application Publication
(10) Pub. No.: US 2025/0240238 A1
(43) Pub. Date: Jul. 24, 2025

(54) DEADLOCK PREVENTION IN A DRAGONFLY USING TWO VIRTUAL LANES

(71) Applicant: CORNELIS NETWORKS, INC., WAYNE, PA (US)

(72) Inventor: ARUNA V. RAMANAN, EASTON, PA (US)

(73) Assignee: CORNELIS NETWORKS, INC., WAYNE, PA (US)

(21) Appl. No.: 18/421,867

(22) Filed: Jan. 24, 2024

(51) Int. Cl. H04L 45/586; H04L 45/42

(52) U.S. Cl. CPC H04L 45/586; H04L 45/42

(57) ABSTRACT

Methods and systems for dynamic port subdivision during link negotiation and initiation are provided. Embodiments include selecting a reference lane from port configuration information for the potential link partner; selecting a subdivision evaluation lane from the port configuration information for of the potential link partner; and comparing a GUID and port number of the reference lane with a GUID and port number of a subdivision evaluation lane. If the GUID and port number of a reference lane and the GUID and port number of a subdivision evaluation lane are not the same, embodiments include subdividing the port into a plurality of subdivided ports.

### BACKGROUND

High-Performance Computing (‘HPC’) refers to the practice of aggregating computing in a way that delivers much higher computing power than traditional computers and servers. HPC, sometimes called supercomputing, is a way of processing huge volumes of data at very high speeds using multiple computers and storage devices linked by a cohesive fabric. HPC makes it possible to explore and find answers to some of the world's biggest problems in science, engineering, business, and others.

HPC systems support complex topologies of switches and links. A Dragonfly topology, for example, is a computing topology in which a collection of switches belonging to a virtual router group (‘VRG’) are connected with intra-group connections called local links and are connected all-to-all with other VRGs with inter-group connections called global links. The Dragonfly provides high bandwidth and low latency for communicat ions within groups while also enabling scalable and efficient communication between groups. This topology is highly scalable and can accommodate a large number of nodes while maintaining good performance characteristics.

The Dragonfly topology is prone to creating credit loops that have the potential to cause deadlocks in the network. Credit loops occur in networks that utilize “credit-based” flow control commonly found in high-speed interconnects, like InfiniBand-style networks or other high-performance networks. In such systems, data transmission is regulated by exchanging “credits” prior to transmitting data. Credits, in this context, are indication sent by receiver as to how much data it can receive from the sender, with sender sending an amount of data less than or equal to the total credits it has at the time of transmission.

A credit loop arises when two or more switches in the network need to exchange credits in a circular manner, with first exchanging with second, second exchanging with third and so on with the last exchanging with the first.

Such a credit loop can cause a deadlock when an egress port at each switch in the loop does not have enough credits from the next switch to send data at the head of its output queue. As a result, none of the switches can transmit data over the port that is part of the credit loop causing the network to hang or become unresponsive.

Virtual lanes are used to manage congestion, reduce contention, and mitigate issues like deadlocks caused by credit loops. Virtual lanes are allocated separate resources, such as buffers, within a physical communication link. Each virtual lane operates independently, allowing traffic to be segregated based on priority or message type. This segregation helps in preventing certain types of congestion that can lead to deadlocks or credit loops.

The most common method to avoid circular dependencies that cause such credit loops is to transition the packets through higher virtual lanes as they traverse the network. Valiant routing algorithm is an example of a routing algorithm usefully implemented for the Dragonfly topology that transitions packets through virtual lanes. Virtual lane transitions in the Valiant routing algorithm have a general ordering rule for virtual lane transitions: L-lev0<G-lev0<L-lev1<L-lev2<G-lev1<L-lev3. One or more of the hops can be missing. However, the ordering relationship must follow the sequence shown above. At no point in the path can a virtual link level be lower than its predecessor. This means that in situations of non-minimal routing, often two global virtual lanes and four virtual lanes are needed per flow.

Protocol deadlock avoidance requires separate request and response per traffic class. This doubles the number of virtual lanes necessary per traffic class. When 8 virtual lanes are supported by a switch ASIC, for example, all 8 available virtual lanes will be consumed for supporting a traffic class, with no scope to support QoS. QoS is meant to separate different traffic classes on their own service channel/virtual lane sets.

The present invention addresses the virtual lane count needed in conventional systems to break circular dependencies, and thus prevent deadlocks in Dragonfly topology.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram illustrating an example high-performance computing environment according to embodiments of the present invention.

FIG. 2 sets forth a line drawing illustrating a VRG for deadlock prevention according to embodiments of the present invention.

FIG. 3 sets forth a line drawing illustrating a switch for deadlock prevention according to embodiments of the present invention.

FIG. 4 sets forth a flowchart illustrating a method for deadlock prevention according to embodiments of the present invention.

FIG. 5 sets forth a flowchart illustrating a method for deadlock prevention according to embodiments of the present invention.

FIG. 6 sets forth a flowchart illustrating a method for deadlock prevention according to embodiments of the present invention.

FIG. 7 sets forth a flowchart illustrating a method for deadlock prevention according to embodiments of the present invention.

### DETAILED DESCRIPTION

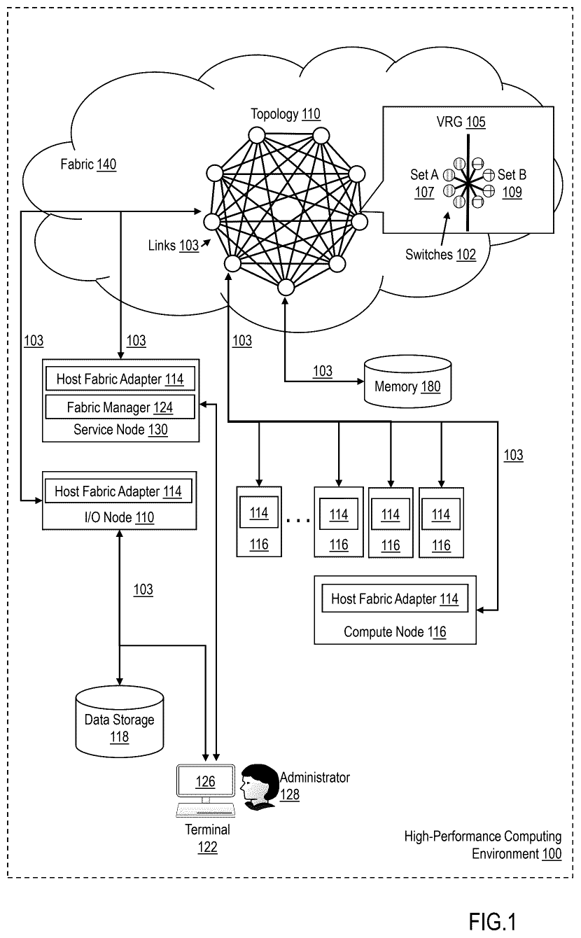

Preventing deadlocks according to embodiments of the present invention is described with reference to the attached drawings. FIG. 1 sets forth a system diagram illustrating an example high-performance computing environment according to embodiments of the present invention. The example high-performance computing environment of FIG. 1 includes a fabric (140) which includes an aggregation of switches (102), links (103), and host fabric adapters (‘HFAs’) (114) integrating the fabric with the devices that it supports. The fabric (140) according to the example of FIG. 1 is a unified computing system that includes interconnected HFA and switches that often look like a weave or a fabric when seen collectively.

The switches (102) of FIG. 1 are multiport modules of automated computing machinery, hardware and firmware, that receive and transmit packets. Typical switches receive packets, inspect packet header information, and transmit the packets according to routing tables configured in the switch. Often switches are implemented as, or with, one or more application specific integrated circuits (‘ASICs’). In many cases, the hardware of the switch implements packet routing and firmware of the switch configures routing tables, performs management functions, fault recovery, and other complex control tasks as will occur to those of skill in the art.

The switches (102) of the fabric (140) of FIG. 1 are connected to other switches with links (103) to form one or more topologies. A topology is implemented as a wiring pattern among switches, HFAs, and other components. Switches, HFAs, and their links may be connected in many ways to form many topologies, each designed to optimize performance for their purpose. Examples of topologies useful according to embodiments of the present invention include HyperX topologies, Star topologies, Dragonflies, Megaflies, Trees, Fat Trees, and many others.

The example of FIG. 1 depicts a Dragonfly topology (110) which is an all-to-all connected set of virtual router groups (105). Virtual router groups (‘VRGs’) (105) are themselves a collection of switches (102) with their own topology-in this case an all-to-all configuration (all links not shown in the Figure).

The switches (102) of FIG. 1 include terminal links to compute nodes, local links to other switches in the same VRG, and global links to switches in other VRGs. As discussed in more detail below, each switch (102) in each VRG (105) is assigned to a particular set (107 and 109) within its VRG (105) for deadlock prevention according to the present invention. In the example of FIG. 1, half the switches of the VRG (105) are assigned to set A (107) and the other half are assigned to set B (109). Each of the local links of a switch is assigned to either ingress traffic from its terminal links or ingress traffic from global links. The configuration of FIG. 1 provides a topology that prevents deadlocks according to embodiments of the present invention. The switches prevent deadlocks generally by routing packets in dependence upon the assigned set of the switch and the link type on either virtual lane level Vlev0 or virtual lane level Vlev1 as described in more detail below

The links (103) themselves may be implemented as copper cables, fiber optic cables, and others as will occur to those of skill in the art. In some embodiments, the use of double density cables may also provide increased bandwidth in the fabric. Such double density cables may be implemented with optical cables, passive copper cables, active copper cables and others as will occur to those of skill in the art.

The example of FIG. 1 includes a service node (130). The service node (130) provides services common to pluralities of compute nodes, loading programs into the compute nodes, starting program execution on the compute nodes, retrieving results of program operations on the compute nodes, and so on. The service node communicates with administrators (128) through a service application interconnect that runs on computer terminal (122).

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a user interface (‘UI’) (126) allowing administrators (128) to configure and administer the fabric manager (124) through a terminal (122), and in so doing, configure and administer the fabric (140). In some embodiments of the present invention, routing algorithms are controlled by the fabric manager (124) which in some cases configures routes from endpoint to endpoint.

The fabric manager (124) of FIG. 1 configures the routing tables in the switches controlling the ingress and egress of packets through each switch, as well as configuring the local links of the VRGs such that local links of a switch are assigned to transmit ingress traffic received from either global links or terminal links. This configuration advantageously provides a vehicle for preventing deadlocks in Dragonfly topologies using only two virtual lanes per flow. A flow, as that term is used in this specification, is the most general path between a source-destination pair in the network.

The example of FIG. 1 includes an I/O node (110) responsible for input and output to and from the high-performance computing environment. The I/O node (110) of FIG. 1 is coupled for data communications to data storage (118) and a terminal (122) providing information, resources, UI interaction and so on to an administrator (128).

The compute nodes (116) of FIG. 1 operate as individual computers including at least one central processing unit (‘CPU’), volatile working memory and non-volatile storage. The hardware architectures and specifications for the various compute nodes vary and all such architectures and specifications are well within the scope of the present invention as will occur to those of skill in the art. Such non-volatile storage may store one or more applications or programs for the compute node to execute.

Each compute node (116) in the example of FIG. 1 has installed upon it a host fabric adapter (114) (‘HFA’). An HFA is a hardware component that facilitates communication between a computer system and a network or storage fabric. It serves as an intermediary between the computer's internal bus architecture and the external network or storage infrastructure. The primary purpose of a host fabric adapter is to enable a computer to exchange data with other devices, such as servers, storage arrays, or networking equipment, over a specific communication protocol. HFAs deliver high bandwidth and increase cluster scalability and message rate while reducing latency.

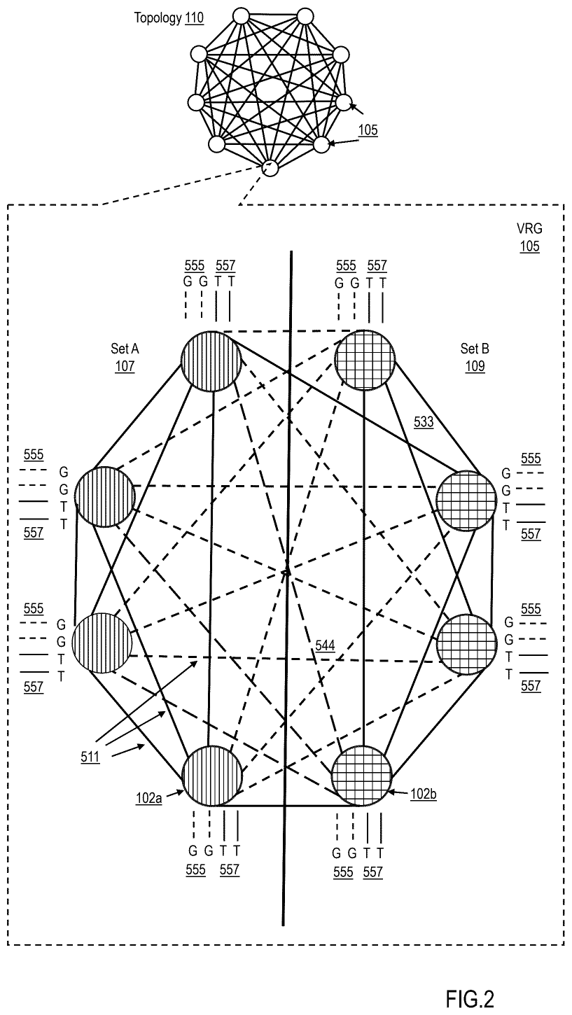

Preventing deadlocks according to embodiments of the present invention relies on a topology in which the switches of VRGs are assigned to sets and local links are assigned to transmit the ingress traffic received on the global links or assigned to transmit the ingress traffic received on the terminal links. Using this configuration and associated routing algorithms deadlocks can be prevented no more than two virtual lanes per flow. For further explanation, FIG. 2 sets forth a line drawing illustrating a VRG for deadlock prevention according to embodiments of the present invention. The VRG (105) of FIG. 2 includes a plurality of switches (102).

Each of the switches (102) of FIG. 2 has terminal links (557) to compute nodes, local links (511) to other switches, and global links (555) to switches in other VRGs. Each of the local links (511) are either a link (533) assigned for ingress traffic from terminal links (577) or a link (544) assigned for ingress traffic from global links (555). In the example of FIG. 2, the terminal links (577) and the local links (533) assigned to transmit the ingress traffic from those terminal links are depicted in solid lines. The global links (555) and the local links (544) assigned to transmit the ingress traffic from those global links are depicted in dashed lines.

The VRG (105) of FIG. 2 includes an even number of switches and half of the switches are assigned to one set (Set A) and the other half of the switches are assigned to another set (Set B). Each switch in Set A (107) is depicted with striped fill and each switch in Set B (109) is depicted with crosshatching. There are an equal number of switches in each set.

Each switch has the same number of global links to other VRGs providing that each switch with the same access to pass-through VRGs for routing as will occur to those of skill in the art. A pass-through VRG is an intermediate group used in non-minimal paths to reduce bottlenecks on global links to the destination VRG.

The example of FIG. 2 includes two sets with an equal number of switches in each set. Embodiments of the present invention may include more than two sets which may have an inequal number of switches as will occur to those of skill in the art.

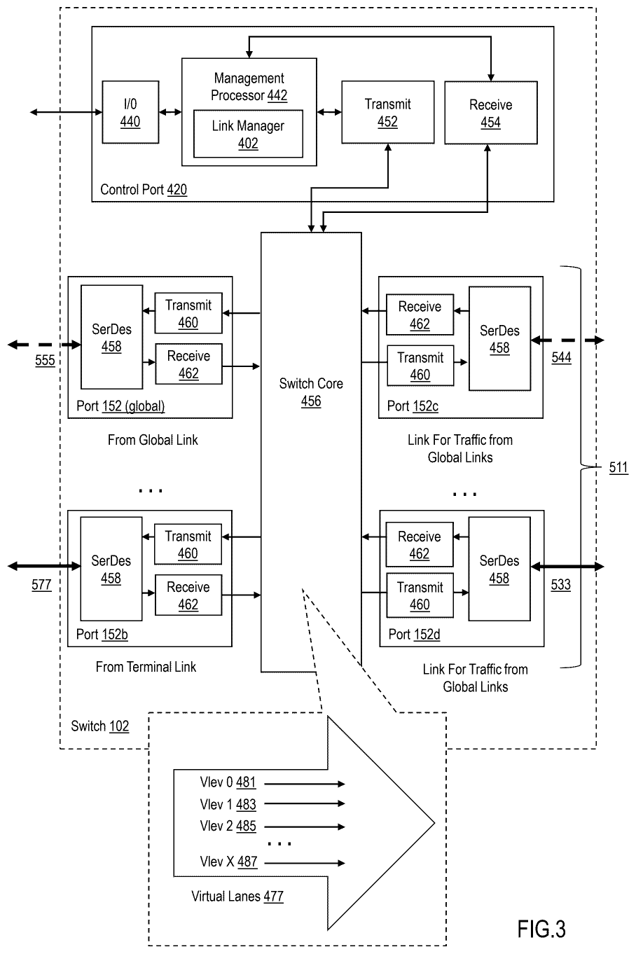

For further explanation, FIG. 3 sets forth a line drawing illustrating a switch for deadlock prevention according to embodiments of the present invention. The example switch (102) of FIG. 3 includes a control port (420), a switch core (456), and a number of ports (152). The control port (420) of FIG. 3 includes an input/output (‘I/O’) module (440), a management processor (442), a transmit controller (452), and a receive controller (454). The control port may be one of the nodes in the network or an external node connected to the network as will occur to those of skill in the art.

The management processor (442) of the example switch of FIG. 3 maintains and updates routing tables for the switch. In the example of FIG. 3, each receive controller maintains the latest updated routing tables.

Each port (152) is coupled with the switch core (456) and a transmit controller (460) and a receive controller (462) and a SerDes (458). Each port in FIG. 3 is connected to a local link (511), a global link (555), or a terminal link (557). The local links (511) of FIG. 3 are assigned to traffic from either a global links or terminal links. The switch of FIG. 3 includes a global link (555) from another VRG and a local link (544) assigned for local traffic of packets received on the global link (555). The switch (102) includes a terminal link (577) from a compute node and a local link (533) assigned for local traffic of packets from the terminal link (533). For ease of explanation, only one global link, one terminal link, and two local links are depicted in the example of FIG. 3. Those of skill in the art will appreciate that switches according to embodiment of the present invention will accommodate many global links, terminal links, and local links.

The switch of FIG. 3 supports virtual lanes. As mentioned above, allocate separate virtual channels within a physical communication link. Each virtual lane operates independently, allowing traffic to be segregated based on priority, message type, or other factors. This segregation helps in preventing certain types of congestion that can lead to deadlocks or credit loops. The example of FIG. 3 illustrates a plurality of virtual lanes Vlev 0 (481), Vlev 1 (483), Vlev 2 (485), through Vlev X (487).

As illustrated in FIG. 3, a switch may support a number of virtual lanes and each virtual lane requires resources allocated to service a flow. The switch of FIG. 3 is configured for deadlock prevention according to embodiments of the present invention, by forming pairs of virtual lanes such that the first lane of the pair is assigned Vlev0 and the second lane is assigned Vlev1 to service a flow from endpoint to endpoint. Different pairs may be used for different service flows.

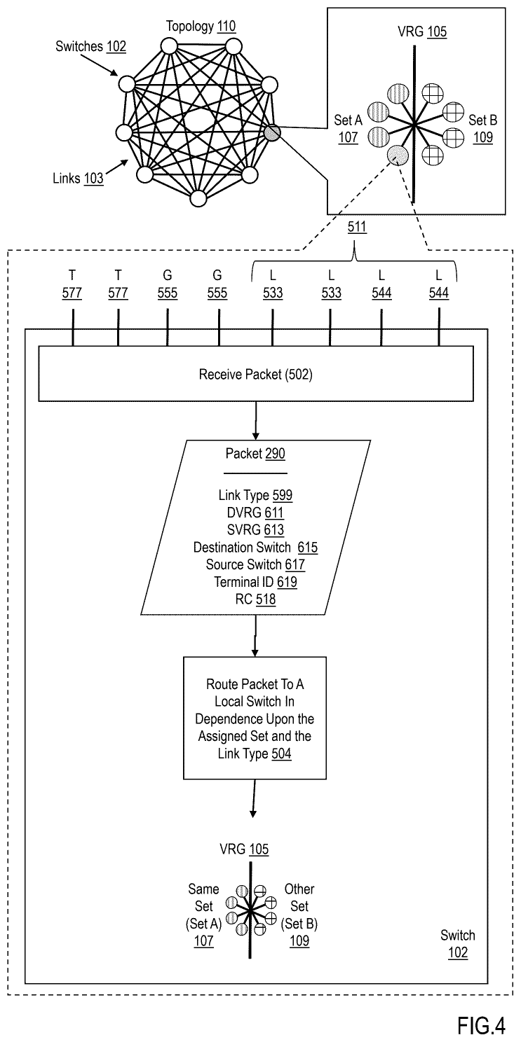

For further explanation, FIG. 4 sets forth a flow chart illustrating an example method of deadlock prevention according to embodiments of the present invention. The method of FIG. 4 is carried out in a topology (110) for high performance computing. The topology (110) includes a plurality of interconnected virtual routing groups (VRGs) (105) that include a plurality of interconnected switches (102).

The switches (102) include terminal links (557) to compute nodes, local links (511) to other switches in the same VRG, and global links (555) to switches in other VRGs. Each switch (102) in each VRG (105) is assigned to a particular set (107 and 109) within its VRG (105) and each of its local links (511) is a link (533) assigned for ingress traffic from terminal links (557) or a link (544) assigned for ingress traffic from global links (555).

The method of FIG. 4 includes receiving (502), by a switch (102) assigned to one (107) of two sets (107 and 109) of a virtual routing group (VRG) (105), a packet (290) on a link.

The method of FIG. 4 includes routing (504) the packet in dependence upon the assigned set and the link type on either virtual lane level Vlev0 or virtual lane level Vlev1.

The method of FIG. 4 represents a general case for explanation and typical embodiments including routing the packet to a local switch in the same set (107) on a link assigned to ingress traffic from terminal links if the packet was received on a terminal link and routing the packet to a local switch in the other set (109) on a link assigned to ingress traffic from global links if the packet was received on a global link.

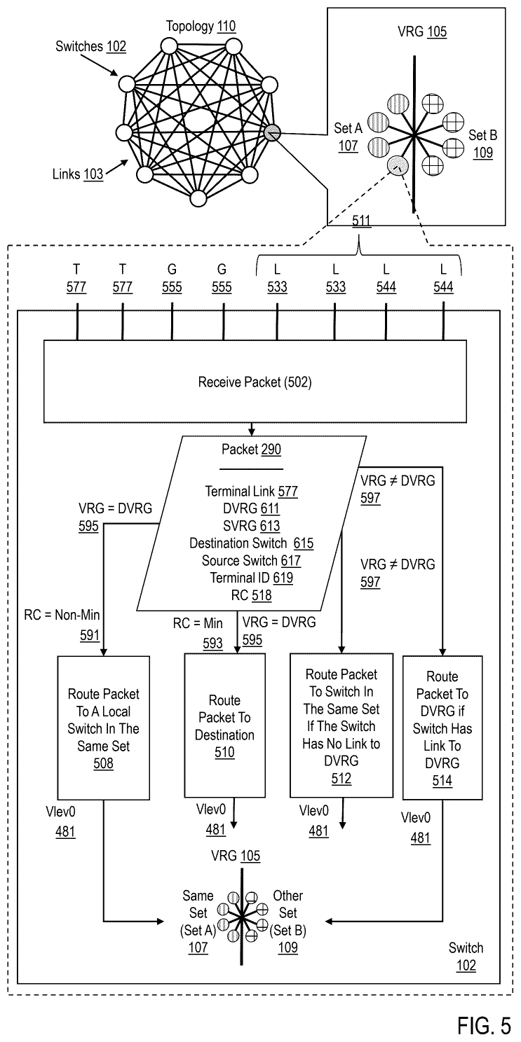

For further explanation, FIG. 5 sets forth a flow chart illustrating an example method of deadlock prevention according to embodiments of the present invention. The method of FIG. 5 includes receiving (502), by a switch (102) assigned to one (107) of two sets (107 and 109) of a virtual routing group (VRG) (105) of a Dragonfly topology, a packet (290).

The switches (102) in the example of FIG. 5 include terminal links (557) to compute nodes, local links (511) to other switches in the same VRG, and global links (555) to switches in other VRGs. Each switch (102) in each VRG (105) is assigned to a particular set (107 and 109) within its VRG (105) and each of its local links (511) is a link (533) assigned for ingress traffic from terminal links (557) or a link (544) assigned for ingress traffic from global links (555).

In the example of FIG. 5 the packet is received on a terminal link (577). The method of FIG. 5 includes routing (508) the packet (290) to a switch in the same set (107) on virtual lane level Vlev0 (481) if the destination is within the VRG (105) and route control is non-minimal (591).

The method of FIG. 5 includes routing (510) the packet to the destination switch on virtual lane level Vlev0 if the destination is within the VRG (105) and route control is minimal.

Because the packet is received on a terminal link, the current VRG is the source VRG. In cases where the current VRG is not the destination VRG, the method of FIG. 5 includes routing (512) the packet (290) to a switch in the same set (107) that has a link to the DVRG on virtual lane level Vlev0 (481) if the switch does not have a link to the DVRG.

If the switch does have a link to the destination VRG, the method of FIG. 5 includes routing (514) the packet (290) to a switch in the DVRG on a global link on virtual lane level Vlev0 (481).

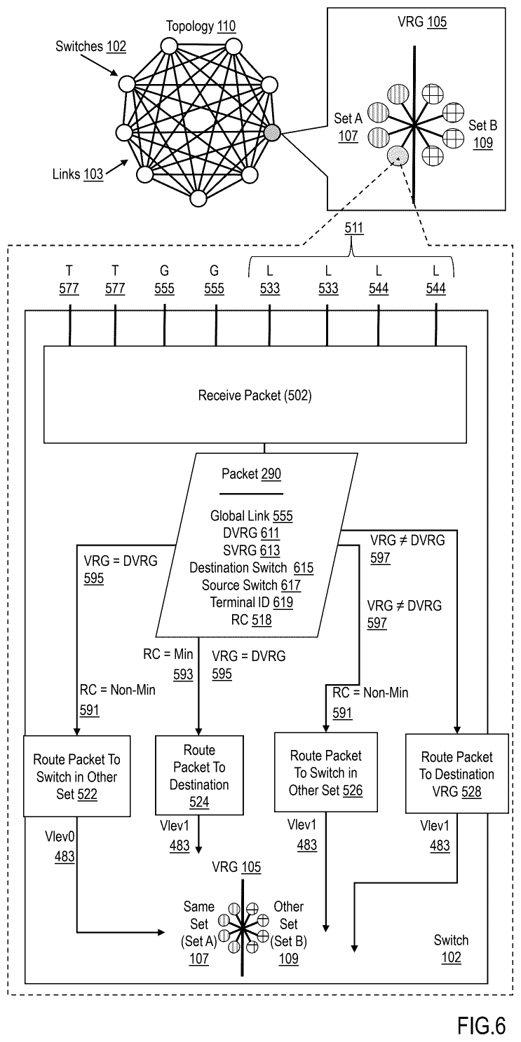

For further explanation, FIG. 6 sets forth a flow chart illustrating a method of deadlock prevention according to embodiments of the present invention. In the example of FIG. 6, the packet is received on a global link (555).

The method of FIG. 6 includes routing (522) the packet to a switch in the other set (109) on virtual lane level Vlev0 (481) if the destination is within the VRG (105) and route control (581) is non-minimal (591).

The method of FIG. 6 includes routing (524) the packet to the destination switch on virtual lane level Vlev1 (483) if the destination is within the VRG (105) and route control (518) is minimal (593).

The method of FIG. 6 includes routing (526) the packet to a switch in the other set (109) on virtual lane level Vlev1 (483) if the destination is not within the VRG (105) and the switch does not have a global link to the destination VRG and route control is non-minimal (591)

The method of FIG. 6 includes routing (528) the packet to a switch in the destination VRG on virtual lane level Vlev1 (483) if the destination is not within the VRG (105) and the switch has a global link to the destination VRG.

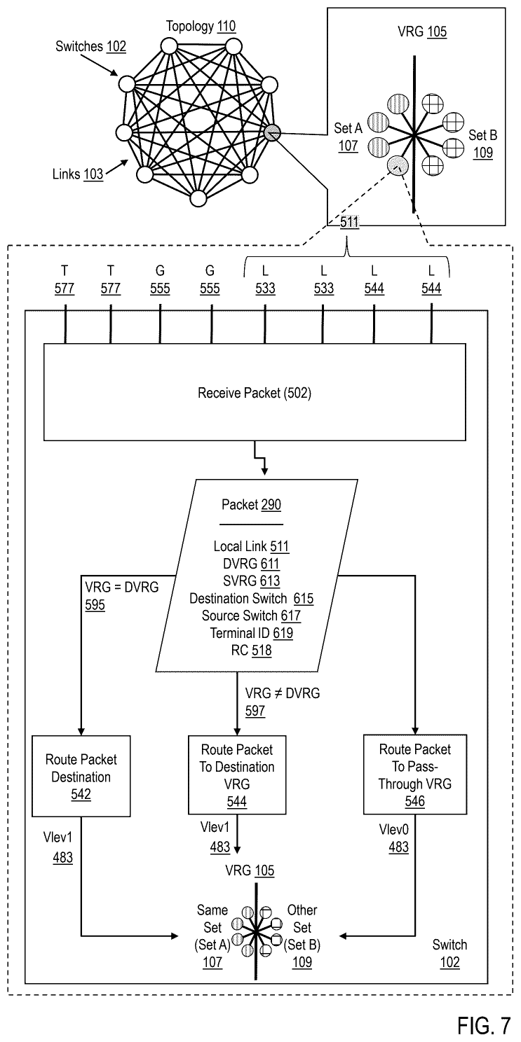

For further explanation, FIG. 7 sets forth a flow chart illustrating an example of deadlock prevention according to embodiments of the present invention. In the example of FIG. 7, the packet is received on a local link. The method of FIG. 7 includes routing (542) the packet to the destination on a local link on virtual lane level Vlev1 (483) if the destination is within the VRG (595);

The method of FIG. 7 includes routing (544) the packet to the destination VRG on a global link on virtual lane level Vlev1 if the destination is not within the VRG (105) and the switch has a link to the destination VRG; and

The method of FIG. 7 includes routing (546) the packet to a switch with a global link to the destination VRG level Vlev1 if the destination is not within the VRG (105) and the switch does not have a link to the destination VRG.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of preventing deadlocks in a high-performance computing environment, the method comprising:
receiving, by a switch assigned to one of two sets of a virtual routing group, a packet on a link; and
routing the packet in dependence upon the assigned set and the link type on either virtual lane level Vlev0 or virtual lane level Vlev1.

2. The method of claim 1 wherein the packet is received on a terminal link and routing the packet in dependence upon the assigned set and the link type on either virtual lane level Vlev0 or virtual lane level Vlev1 further comprises:
routing the packet to a switch in the same set on virtual lane level Vlev0 if the destination is within the VRG and route control is non-minimal;
routing the packet to the destination switch on virtual lane level Vlev1 if the destination is within the VRG and route control is minimal; and
routing the packet to a switch in the same set on virtual lane level Vlev0 if the destination is not within the VRG and the switch does not have a global link to the destination VRG; and
routing the packet to a switch in the destination VRG on virtual lane level Vlev0 if the destination is not within the VRG and the switch has a global link to the destination VRG.

3. The method of claim 1 wherein the packet is received on a global link and routing the packet in dependence upon the assigned set and the link type on either virtual lane level Vlev0 or virtual lane level Vlev1 further comprises:
routing the packet to a switch in the other set on virtual lane level Vlev0 if the destination is within the VRG and route control is non-minimal;
routing the packet to the destination switch on virtual lane level Vlev1 if the destination is within the VRG and route control is minimal; and
routing the packet to a switch in the other set on virtual lane level Vlev1 if the destination is not within the VRG and the switch does not have a global link to the destination VRG and route control is non-minimal.
routing the packet to a switch in the destination VRG on virtual lane level Vlev1 if the destination is not within the VRG and the switch has a global link to the destination VRG.

4. The method of claim 1 wherein the packet is received on a local link and routing the packet in dependence upon the assigned set and the link type on either virtual lane level Vlev0 or virtual lane level Vlev1 further comprises:
routing the packet to the destination on a local link on virtual lane level Vlev1 if the destination is within the VRG;
routing the packet to the destination VRG on a global link on virtual lane level Vlev1 if the destination is not within the VRG and the switch has a link to the destination VRG; and
routing the packet to a pass-through VRG on a global link on virtual lane level Vlev0 if the destination is not within the VRG and the switch does not have a link to the destination VRG.

5. The method of claim 1 wherein the VRG comprises a plurality of switches arranged in an all-to-all topology and both sets include the same number of switches.

6. The method of claim 1 where in the VRG comprises a virtual routing group in a Dragonfly topology.

7. A system of preventing deadlocks in a high-performance computing environment, the system comprising:
means for receiving, by a switch assigned to one of two sets of a virtual routing group, a packet on a link; and
means for routing the packet in dependence upon the assigned set and the link type on either virtual lane level Vlev0 or virtual lane level Vlev1.

8. The system of claim 7 wherein the packet is received on a terminal link and routing the packet in dependence upon the assigned set and the link type on either virtual lane level Vlev0 or virtual lane level Vlev1 further comprises:
means for routing the packet to a switch in the same set on virtual lane level Vlev0 if the destination is within the VRG and route control is non-minimal;
means for routing the packet to the destination switch on virtual lane level Vlev1 if the destination is within the VRG and route control is minimal; and
means for routing the packet to a switch in the same set on virtual lane level Vlev0 if the destination is not within the VRG and the switch does not have a global link to the destination VRG; and
means for routing the packet to a switch in the destination VRG on virtual lane level Vlev0 if the destination is not within the VRG and the switch has a global link to the destination VRG.

9. The system of claim 7 wherein the packet is received on a global link and means for routing the packet in dependence upon the assigned set and the link type on either virtual lane level Vlev0 or virtual lane level Vlev1 further comprises:
means for routing the packet to a switch in the other set on virtual lane level Vlev0 if the destination is within the VRG and route control is non-minimal;
means for routing the packet to the destination switch on virtual lane level Vlev1 if the destination is within the VRG and route control is minimal; and
means for routing the packet to a switch in the other set on virtual lane level Vlev1 if the destination is not within the VRG and the switch does not have a global link to the destination VRG and route control is non-minimal.
means for routing the packet to a switch in the destination VRG on virtual lane level Vlev1 if the destination is not within the VRG and the switch has a global link to the destination VRG.

10. The system of claim 7 wherein the packet is received on a local link and means for routing the packet in dependence upon the assigned set and the link type on either virtual lane level Vlev0 or virtual lane level Vlev1 further comprises:
means for routing the packet to the destination on a local link on virtual lane level Vlev1 if the destination is within the VRG;
means for routing the packet to the destination VRG on a global link on virtual lane level Vlev1 if the destination is not within the VRG and the switch has a link to the destination VRG; and
means for routing the packet to a pass-through VRG on a global link on virtual lane level Vlev0 if the destination is not within the VRG and the switch does not have a link to the destination VRG.

11. The system of claim 7 wherein the VRG comprises a plurality of switches arranged in an all-to-all topology and both sets include the same number of switches.

12. The system of claim 7 where in the VRG comprises a virtual routing group in a Dragonfly topology.
